(19) United States
(12) Patent Application Publication
(10) Pub. No.: US 2010/0177913 A1
(43) Pub. Date: Jul. 15, 2010

(54) MICROPHONE PREAMPLIFIER CIRCUIT AND VOICE SENSING DEVICES

(75) Inventors: Jui-Te Chiu, Hsinchu City (TW); Li-Te Wu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/351,997

(22) Filed: Jan. 12, 2009

(51) Int. Cl. H04R 3/00

(52) U.S. Cl. 381/111

(57) ABSTRACT

A microphone preamplifier circuit is provided in a system on chip. An amplifier comprises a first input end, a second input end, and an output end. A bias voltage is provided by a bias voltage source. A first sensor is coupled to the first input end and the bias voltage source for sensing a first physical parameter and a second physical parameter. A second sensor is coupled to the second input end and the bias voltage source for sensing the first physical parameter, wherein the second sensor is insensitive to the second physical parameter. The output end of the amplifier outputs a difference of the first and second input ends whereby noises and interferences are reduced.

### BACKGROUND OF THE INVENTION

1. Field of the Invention

The invention relates to a microphone preamplifier, and in particular, to a circuit structure that eliminates interferences within the circuit.

2. Description of the Related Art

FIG. 1 shows a conventional microphone preamplifier circuit. An amplifier 150 is implemented in an integrated chip 160, having a first input end (+), a second input end (−) and an output end. The integrated chip 160 has a pad 102 for coupling signals from outside of the chip to the amplifier 150. Meanwhile, the first input end is biased by a bias resistor 130 and a reference voltage source 140 inside of the chip. A microphone cartridge 120 is coupled between a bias voltage source 110 and the pad 102. The output end of the amplifier 150 is connected to the second input end (−), whereby a pre-amplified result of the microphone cartridge 120 is output (denoted as Vₒᵤₜ). The microphone cartridge 120 may be an electret condenser microphone (ECM) comprising a moving diaphragm and a fixed back-plate functioning as an equivalent capacitor. The microphone cartridge 120 may also be a Micro mechanical electrical system (MEMS) microphone.

As known, voice is a kind of air pressure variation, and the microphone cartridge 120 can sense the air pressure variation to induce a charge variation. Thereby, voice signals are transposed into voltage signals. The amplifier 150 serves as a buffer to output a sensed voltage signal. Conventionally, the bias voltage source 110 exhibits significant noise, and the microphone cartridge 120 is sensitive to radio frequency (RF) interferences. For example, RF interference may be coupled to the microphone cartridge 120 to introduce a voltage deviation on the first input end (+). Thus, quality of microphone preamplifiers is hindered due to the circuit structure.

### BRIEF SUMMARY OF THE INVENTION

An exemplary embodiment of a voice sensing device is provided. The integrated chip comprises an amplifier, a first pad, and a second pad. The bias voltage source is deployed on the circuit board for providing a bias voltage. The first sensor is deployed on the circuit board, coupled to the first pad and the bias voltage source, for sensing a first physical parameter and a second physical parameter. The second sensor is deployed on the circuit board, coupled to the second pad, for sensing the first physical parameter, wherein the second sensor is insensitive to the second physical parameter.

Another embodiment of a voice sensing device is provided, comprising a circuit board, a bias voltage source deployed on the circuit board, and a system on chip. The system on chip is deployed on the circuit board, comprising a first module, a second module and a third module. The first module comprises a first sensor coupled to the first input end and the bias voltage source for sensing a first physical parameter and a second physical parameter. The second module comprises a second sensor coupled to the second input end for sensing the first physical parameter, wherein the second sensor is insensitive to the second physical parameter. The third module comprises an amplifier having a first input end, a second input end, and an output end, wherein the output end of the amplifier outputs a difference of the first and second input ends.

A further embodiment of a voice sensing device is provided, comprising a system on chip. A pre-amplifier circuit is implemented in the system on chip, comprising a bias voltage source, a first module, and a second module. The first sensor is coupled to the first input end and the bias voltage source, for sensing a first physical parameter and a second physical parameter. The second sensor is coupled to the second input end, for sensing the first physical parameter, wherein the second sensor is insensitive to the second physical parameter. A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional microphone preamplifier circuit implemented in an integrated chip;

FIG. 2 shows an embodiment of a voice sensing device according to the invention;

FIG. 3 shows another embodiment of a voice sensing device according to the invention; and.

FIG. 4 shows another embodiment of a voice sensing device according to the invention.

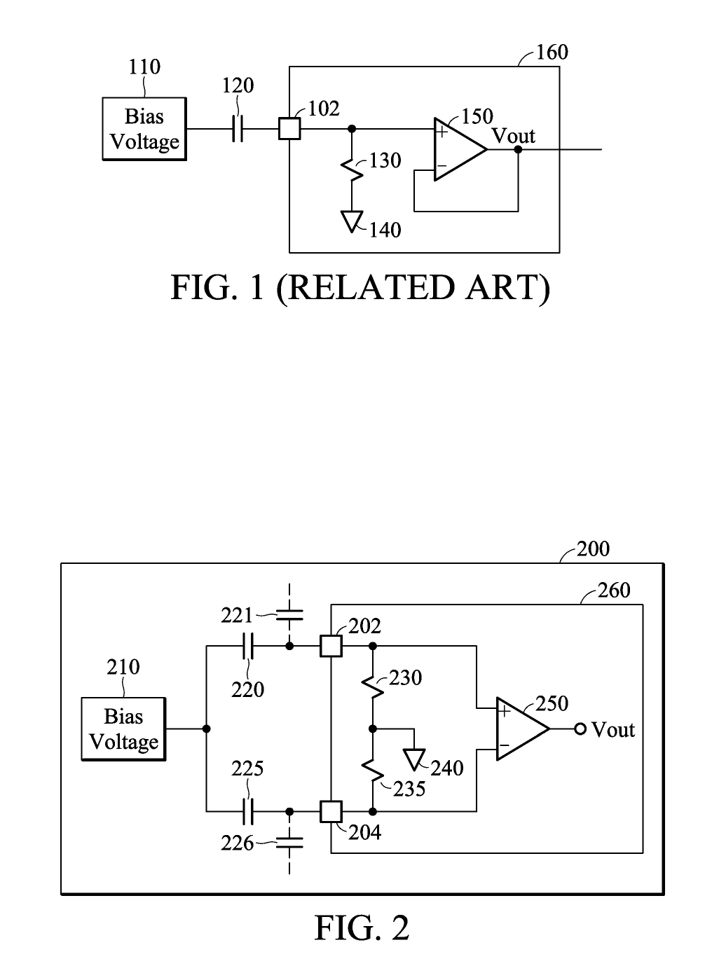

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

A system on chip solution is proposed to minimize noise and interference introduced by off chip components and physical layout of the system on chip.

FIG. 2 shows another embodiment of a voice sensing device according to the invention. The voice sensing device is typically implemented on a circuit board 200. The voice sensing device may be a various type portable device such as a digital audio recorder, a mobile phone, or a camera. The circuit board 200 is usually referred to as a Printed Circuit Board (PCB). In the circuit board 200, a system on chip 260 with two pads 202 and 204 is implemented. A preamplifier circuit is implemented partially within the system on chip 260 and partially on the circuit board 200. In the system on chip 260, the amplifier 250 comprises a first input end (+), a second input end (−), and an output end. The system on chip 260 comprises a first pad 202 coupled to the first input end (+), and a second pad 204 coupled to the second input end (−).

A first sensor 220 is implemented on the circuit board 200, coupled to the first pad 202 for sensing a first physical parameter and a second physical parameter. Likewise, a second sensor 225 is implemented on the circuit board 200, coupled to the second pad 204 for sensing the first physical parameter. That is, the difference between the first sensor 220 and the second sensor 225 is the sensitivity of the second physical parameter. In the embodiment, the first physical parameter can be radio frequency (RF) interferences induced inside of the integrated chip, noises introduced by the bias voltage source, or both. The second physical parameter is air pressure variation, which is also referred to as voices. In this way, the unwanted interferences and noises can be effectively subtracted to generate a quality audio signal.

A bias voltage source 210 is also deployed on the circuit board 200 for providing a bias voltage. The first sensor 220 is a microphone cartridge for sensing the first physical parameter and the second physical parameter. The second sensor 225 is a capacitor, and the microphone cartridge may be a MicroElectrical-Mechanical System (MEMS) microphone or an Electret condenser microphone (ECM). To drive a MEMS microphone, the first sensor 210 must be a charge pump providing a DC bias voltage of 12V. But if the first sensor 220 is an ECM, the first sensor 210 can be a ground voltage (0V).

In the embodiment, the reference voltage source 240, first bias resister 230 and second bias resistor 235 are implemented inside of the system on chip 260. The first bias resistor 230 is coupled to the first input end (+) and the reference voltage source 240. The second bias resistor 235 is coupled to the second input end (−) and the reference voltage source 240.

The bias voltage provided by the bias voltage source 210 is modeled as:

V₂₁₀=V_{b}+Vₙ (1),

where V_{b} is the DC voltage of the bias voltage source 210, and Vₙ is the inherent noise voltage accompanied with the bias voltage. As described, for MEMS microphones, DC voltage V_{b} is 12V.

In the system on chip 260, a reference voltage source 240 is provided. A first bias resistor 230 is coupled to the first input end (+) and the reference voltage source 240. A second bias resistor 235 coupled to the second input end (−) and the reference voltage source 240.

The voltage sensed by the first sensor 220 is modeled as:

V₂₂₀=Vᵣ+V_{b}(x/d)+Vₙ+V_{RF} (2),

where d is the distance between diaphragm and the back plate, and x is the movement of the diaphragm under air pressure. V_{RF} is the radio frequency interference voltage induced on the first sensor 220. Vᵣ is the reference voltage provided by the reference source 240.

Meanwhile, the voltage sensed by the second sensor 225 is modeled as:

V₂₂₅=Vᵣ+Vₙ+V_{RF} (3).

If the preamplifier 150 has a gain G, the output voltage Vₒᵤₜ on the output end of the preamplifier is:

Vₒᵤₜ=G(V₂₂₀−V₂₂₅)=GV_{b}(x/d) (4).

It is shown that the RF noise interference and bias voltage noise are effectively eliminated from the output voltage Vₒᵤₜ.

Unwanted coupling effects may occur. For example, the capacitors 221 and 226, with interference from voltage source lines or due to physical layout, are coupled to the first sensor 220 and second sensor 225, respectively. A voltage deviation induced on the first pad 202 is:

Vₚₙ[C₂₂₁/(C₂₂₀+C₂₂₁)] (5).

Likewise, a voltage deviation induced on the second pad is:

Vₚₙ[C₂₂₆/(C₂₂₅+C₂₂₆)] (6),

where Vₚₙ is a potential on the voltage source lines. C₂₂₀ is the capacitance of the first sensor 220, and C₂₂₅ is the capacitance of the second sensor 225. Through a particular design, the coupling effect can be effectively eliminated if the formula (5) is approximated to formula (6).

In the embodiment, the microphone cartridge 220 may be a MicroElectrical-Mechanical System (MEMS) microphone, and consequently, the bias voltage source 210 should be a charge pump circuit to provide sufficient bias voltage for the MEMS microphone. Alternatively, the microphone cartridge 220 may also be an Electret condenser microphone (ECM), and there are various types of microphones adaptable in the embodiment, which is not limited in the invention.

Since both the first sensor 220 and second sensor 225 are deposited outside the system on chip 260, noise and interference can be effectively eliminated as described in equations (1)-(6).

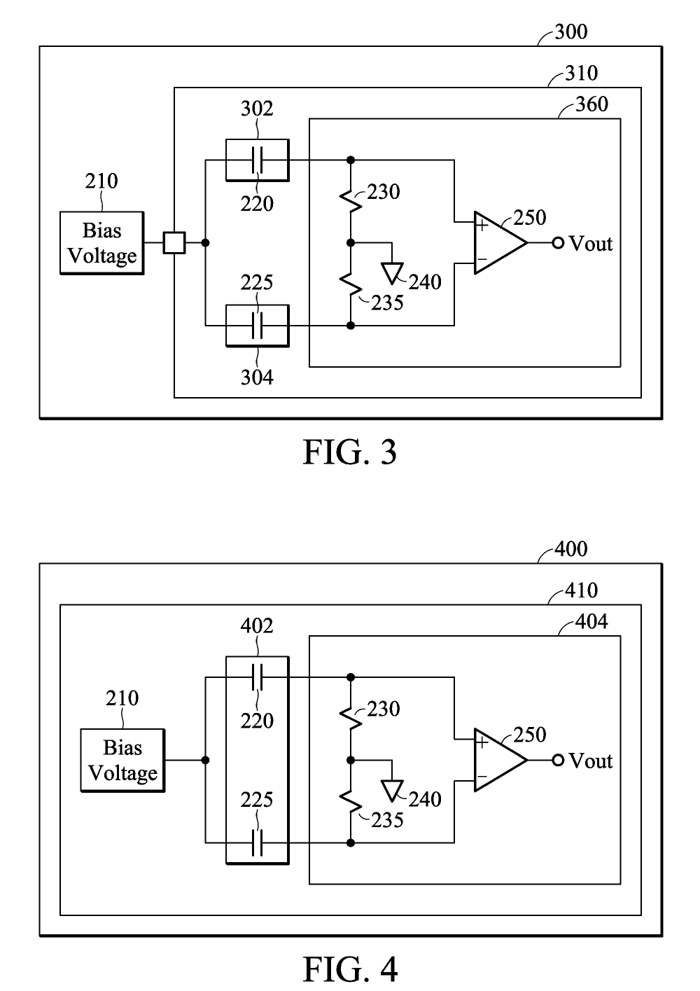

FIG. 3 shows another embodiment of a voice sensing device according to the invention. The voice sensing device is typically implemented on a circuit board 300. In the circuit board 300, a system on chip 310 is implemented with three modules 302, 304 and 306. A preamplifier circuit is implemented partially within three modules and partially on the circuit board 300. For example, the amplifier 250 is implemented in the third module 306. A first sensor 220 is implemented in the first module 302, coupled to the first input end (+) for sensing a first physical parameter and a second physical parameter. Meanwhile, a second sensor 225 is implemented on the second module 304, coupled to the second input end (−) for sensing the first physical parameter.

In the circuit board 300, the bias voltage source 210 is deployed off chip, providing the bias voltage to the first sensor 220 and second sensor 225 through a pad 212. Since the first sensor 220 and second sensor 225 is implemented within the system on chip 310, the sensed interference may be from different sources. Nevertheless, through careful design, the differential circuit structure can effectively overcome the interferences.

FIG. 4 shows another embodiment of a voice sensing device according to the invention. The voice sensing device is represented as a circuit board 400. The voice sensing device itself may also be referred to as a pre-amplifier circuit, in which a system on chip 410 is implemented with two modules 402 and 404, whereby a preamplifier circuit is implemented partially therein. For example, the amplifier 250 is implemented in the first module 404. A first sensor 220 is implemented in the second module 402, coupled to the first input end (+) for sensing a first physical parameter and a second physical parameter. Meanwhile, a second sensor 225 is also implemented in the second module 402, coupled to the second input end (−) for sensing the first physical parameter.

In the circuit board 400, the bias voltage source 210 is also deployed inside of the system on chip 410, providing the bias voltage to the first sensor 220 and second sensor 225 through inherent wirings. Since the first sensor 220 and second sensor 225 are implemented within the same module 402, the sensed interference may be subsequently identical. Thus, the output from the amplifier can have a better quality audio signal wherein the interferences are completely eliminated.

There may be various layout approaches to implement a pre-amplifier circuit. Components such as a first sensor, second sensor, amplifier, bias voltage source and resistors may be either off chip or within chip, thus the combination of different implementations is various, by a circuit board, by a system on chip, or by a combination of the circuit board with the system on chip.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A voice sensing device, comprising:
a circuit board;
a system on chip deployed on the circuit board, comprising:
an amplifier, comprising a first input end, a second input end, and an output end;
a first pad, coupled to the first input end; and
a second pad, coupled to the second input end;
a bias voltage source, deployed on the circuit board for providing a bias voltage;
a first sensor, deployed on the circuit board, coupled to the first pad and the bias voltage source, for sensing a first physical parameter and a second physical parameter; and
a second sensor, deployed on the circuit board, coupled to the second pad, for sensing the first physical parameter, wherein the second sensor is insensitive to the second physical parameter, and the output end of the amplifier outputs a difference of the first and second input ends.

2. The voice sensing device as claimed in claim 1, wherein:
the first sensor is a microphone cartridge; and
the second physical parameter is air pressure variation;

3. The voice sensing device as claimed in claim 2, wherein:
the second sensor is a capacitor; and
the first physical parameter is radio frequency (RF) interference induced inside of the system on chip, noise introduced by the bias voltage source, or both.

4. The voice sensing device as claimed in claim 2, wherein:
the microphone cartridge is a MicroElectrical-Mechanical System (MEMS) microphone; and
the bias voltage source is a charge pump circuit.

5. The voice sensing device as claimed in claim 2, wherein the microphone cartridge is an Electret condenser microphone (ECM).

6. The voice sensing device as claimed in claim 2, wherein the system on chip further comprises:
a reference voltage source;
a first bias resistor coupled to the first input end and the reference voltage source; and
a second bias resistor coupled to the second input end and the reference voltage source.

7. A voice sensing device, comprising:
a circuit board;
a bias voltage source, deployed on the circuit board for providing a bias voltage;
a system on chip, deployed on the circuit board, comprising:
a first module, comprising a first sensor coupled to the first input end and the bias voltage source, for sensing a first physical parameter and a second physical parameter; and
a second module, comprising a second sensor coupled to the second input end, for sensing the first physical parameter, wherein the second sensor is insensitive to the second physical parameter;
a third module, comprising an amplifier having a first input end, a second input end, and an output end, wherein the output end of the amplifier outputs a difference of the first and second input ends.

8. The voice sensing device as claimed in claim 7, wherein:
the first sensor is a microphone cartridge; and
the second physical parameter is air pressure variation;

9. The voice sensing device as claimed in claim 8, wherein:
the second sensor is a capacitor; and
the first physical parameter is radio frequency (RF) interference induced inside of the system on chip, noise introduced by the bias voltage source, or both.

10. The voice sensing device as claimed in claim 8, wherein:
the microphone cartridge is a MicroElectrical-Mechanical System (MEMS) microphone; and
the bias voltage source is a charge pump circuit.

11. The voice sensing device as claimed in claim 8, wherein the microphone cartridge is an Electret condenser microphone (ECM).

12. The voice sensing device as claimed in claim 8, wherein the system on chip further comprises:
a reference voltage source;
a first bias resistor coupled to the first input end and the reference voltage source; and
a second bias resistor coupled to the second input end and the reference voltage source.

13. A voice sensing device, comprising:
a system on chip, comprising:
a bias voltage source, deployed in the system on chip for providing a bias voltage;
a first module, comprising an amplifier having a first input end, a second input end, and an output end; and
a second module, comprising:
a first sensor coupled to the first input end and the bias voltage source, for sensing a first physical parameter and a second physical parameter; and
a second sensor coupled to the second input end, for sensing the first physical parameter, wherein the second sensor is insensitive to the second physical parameter,
wherein the output end of the amplifier outputs a difference of the first and second input ends.

14. The voice sensing device as claimed in claim 13, wherein:
the first sensor is a microphone cartridge; and
the second physical parameter is air pressure variation;

15. The voice sensing device as claimed in claim 14, wherein:
the second sensor is a capacitor; and
the first physical parameter is radio frequency (RF) interference induced inside of the system on chip, noise introduced by the bias voltage source, or both.

16. The voice sensing device as claimed in claim 14, wherein:
the microphone cartridge is a MicroElectrical-Mechanical System (MEMS) microphone; and
the bias voltage source is a charge pump circuit.

17. The voice sensing device as claimed in claim 14, wherein the microphone cartridge is an Electret condenser microphone (ECM).

18. The voice sensing device as claimed in claim 14, wherein the first module in the system on chip further comprises:
a reference voltage source;
a first bias resistor coupled to the first input end and the reference voltage source; and
a second bias resistor coupled to the second input end and the reference voltage source.
